(19) United States
(12) Patent Application Publication
(10) Pub. No.: US 2026/0367927 A1
(43) Pub. Date: Nov. 19, 2026

(54) SYSTEMS AND METHODS FOR PERFORMING DYNAMICALLY LOADED TASKS BY LEVERAGING ARTIFICIAL INTELLIGENCE SERVICES

(71) Applicant: Juniper Networks, Inc., Sunnyvale, CA (US)

(72) Inventors: Nilesh Simaria, Pleasanton, CA (US); Sai Ramamoorthy, Sunnyvale, CA (US); Piyush Rai, San Jose, CA (US); Sanjay Kumar, Tracy, CA (US)

(21) Appl. No.: 19/207,775

(22) Filed: May 14, 2025

(51) Int. Cl. G06F 9/445; G06F 9/54

(52) U.S. Cl. CPC G06F 9/445; G06F 9/542

(57) ABSTRACT

A method for provisioning automatic configurations may involve detecting a connection between a computing device and an additional computing device that runs a first protocol and is communicatively coupled to a controller via a network fabric. In one example, the method may also involve determining, via a second protocol, that the computing device is unconfigured for operation in the network fabric. Additionally or alternatively, the method may further involve enabling the controller to configure the computing device for operation in the network fabric via a provisioning mechanism in response to determining that the computing device is unconfigured for operation in the network fabric. Various other devices, systems, and methods are also disclosed.

### BACKGROUND

The instant disclosure identifies and addresses a need for additional and improved systems and methods for performing dynamically loaded tasks by leveraging artificial intelligence (AI) services.

As will be described in greater detail below, the instant disclosure generally relates to systems and methods for performing dynamically loaded tasks by leveraging AI services. In one example, a system for accomplishing such a task may include and/or represent a storage device and/or circuitry. In this example, the storage device may be configured to store data associated with an operating system running on a network device. In addition, the circuitry may be configured to (1) collect, from the data associated with the operating system, a subset of data pertinent to a task for the network device, (2) prepare, based at least in part on the subset of data, an input for an AI service in connection with the task, and then (3) receive, from the AI service, an output corresponding to the task upon injecting the input into the AI service.

Similarly, a corresponding computer-implemented method may involve (1) storing, by circuitry of a network device, data associated with an operating system of the network device in a storage device, (2) collecting, by the circuitry from the data associated with the operating system, a subset of data pertinent to a task for the network device, (3) preparing, by the circuitry based at least in part on the subset of data, an input for an AI service in connection with the task, and then (4) receiving, by the circuitry from the AI service, an output corresponding to the task upon injecting the input into the AI service.

A corresponding non-transitory computer-readable medium may include and/or represent one or more computer-executable instructions. When executed by circuitry of a network device, those computer-executable instructions may cause the network device to (1) store, in a storage device, data associated with an operating system of the network device, (2) collect, from the data associated with the operating system, a subset of data pertinent to a task for the network device, (3) prepare, based at least in part on the subset of data, an input for an AI service in connection with the task, and then (4) receive, from the AI service, an output corresponding to the task upon injecting the input into the AI service.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary system for performing dynamically loaded tasks by leveraging AI services in accordance with one or more embodiments of this disclosure.

FIG. 2 is an illustration of an exemplary system for performing dynamically loaded tasks by leveraging AI services in accordance with one or more embodiments of this disclosure.

FIG. 3 is an illustration of an exemplary input prepared by an operating system of a network device for injection into an AI service in accordance with one or more embodiments of this disclosure.

FIG. 4 is an illustration of an exemplary implementation in which an operating system of a network device leverages an AI service to complete a dynamically loaded task in accordance with one or more embodiments of this disclosure.

FIG. 5 is an illustration of an exemplary input prepared by an operating system of a network device for injection into an AI service in accordance with one or more embodiments of this disclosure.

FIG. 6 is a flow diagram of an exemplary method for performing dynamically loaded tasks by leveraging AI services in accordance with one or more embodiments of this disclosure.

FIG. 7 is a block diagram of an exemplary computing system capable of implementing and/or being used in connection with one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure describes various systems and methods for performing dynamically loaded tasks by leveraging and/or bootstrapping AI services, such as a generative AI bot, a chatbot, and/or a large language model (LLM). As will be explained in greater detail below, embodiments of the instant disclosure may an operating system (OS) running on a network device to make hypertext transfer protocol (HTTP) calls to leverage and/or access the advanced capabilities of an LLM (e.g., CHATGPT, GROK, etc.). In some examples, the OS may detect an event and/or periodic trigger associated with a task for the network device (e.g., auditing a configuration, diagnosing an issue based on syslog messages, monitoring the health and/or performance of the network device, etc.). In one example, the OS may collect local data pertinent to the task and then prepare an input that includes the local data along with a prompt, query, and/or set of instructions in connection with the task for the LLM. In this example, after injecting the input into the LLM, the OS may receive an output corresponding to the task from the LLM.

In some examples, the OS may publish some or all of the output to an AI-driven data bus to distribute messages and/or data corresponding to the task. In one example, the OS may tag those messages and/or data with identifiers for distribution to subscribers interested in such messages and/or data. For example, the AI-driven data bus may function and/or serve as a distribution channel through which messages and/or data of interest are published to the subscribers’ feeds (e.g., akin to web feeds) and/or corresponding applications running on the subscribers’ devices.

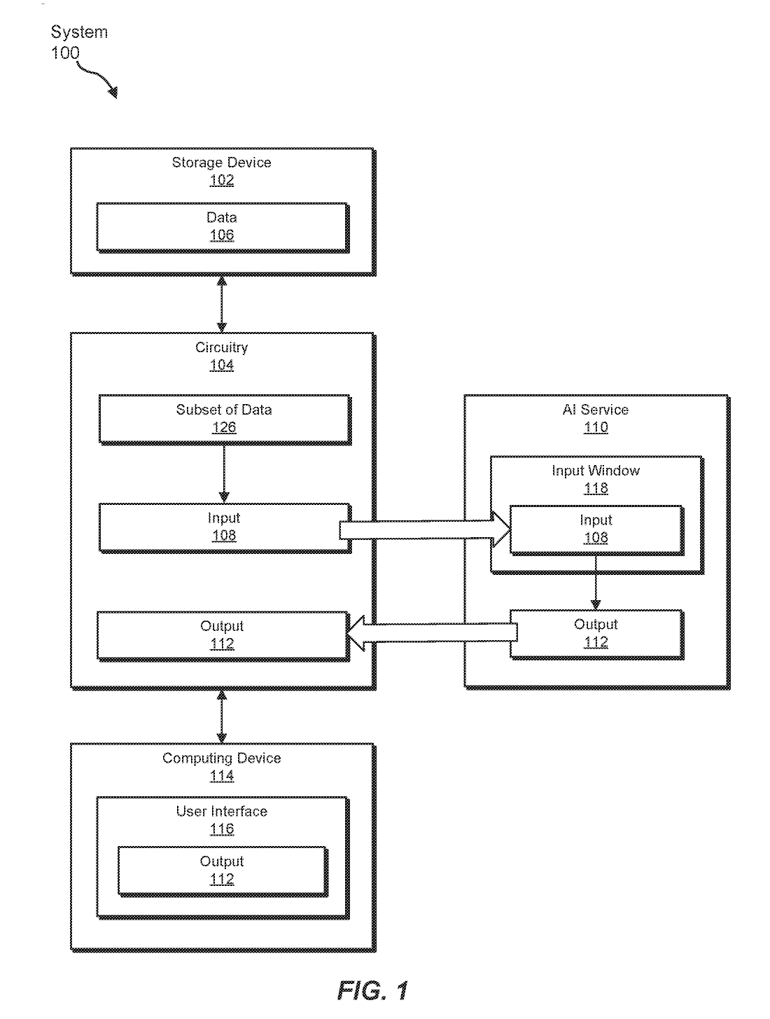

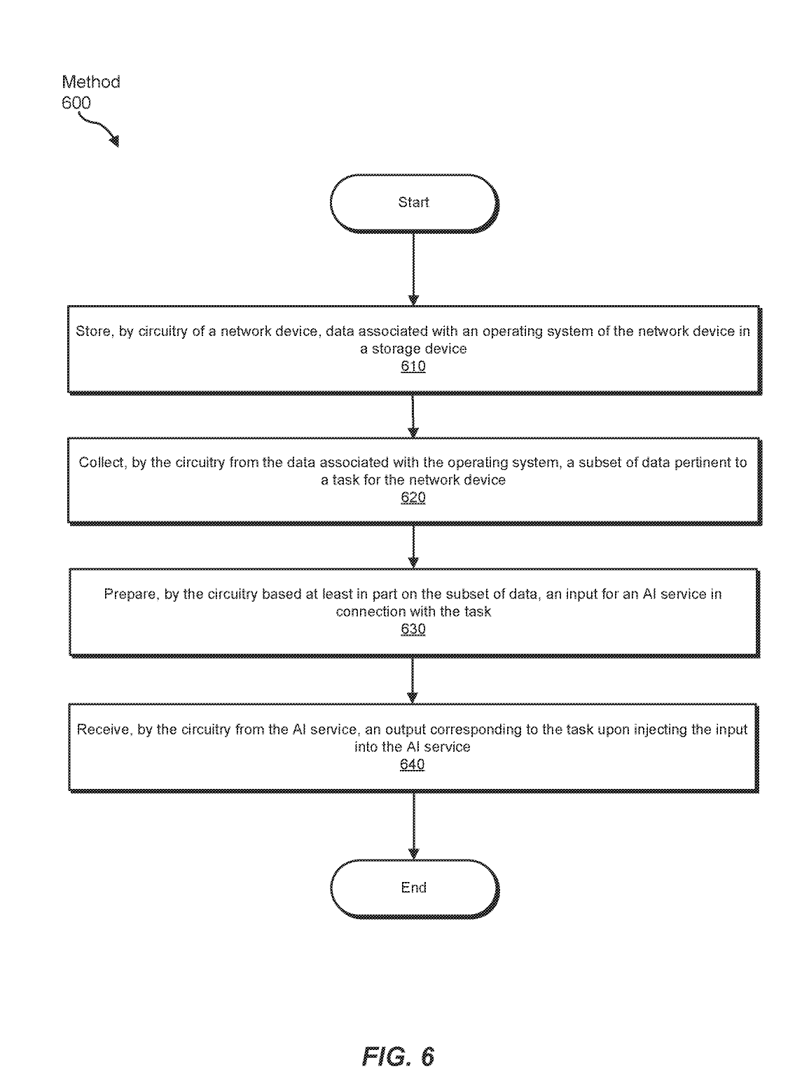

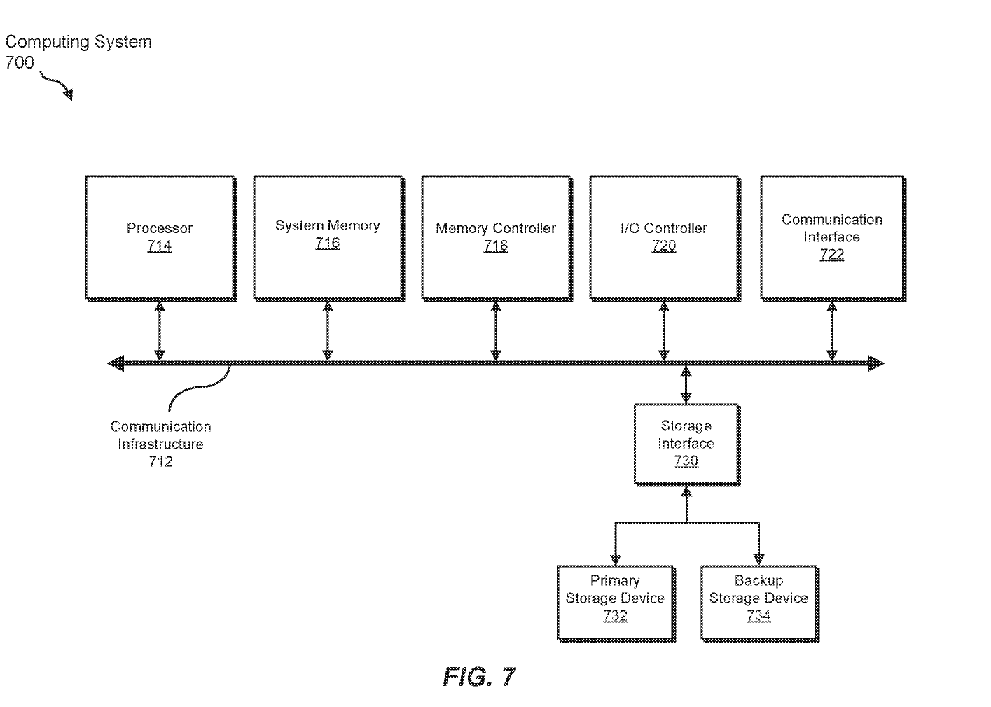

The following will provide, with reference to FIGS. 1-5, detailed descriptions of exemplary devices, systems, and corresponding implementations for performing dynamically loaded tasks by leveraging AI services. Detailed descriptions of an exemplary method for performing dynamically loaded tasks by leveraging AI services will be provided in connection with FIG. 6. In addition, detailed descriptions of an exemplary computing system for carrying out these methods will be provided in connection with FIG. 7.

FIG. 1 illustrates an exemplary system 100 capable of performing dynamically loaded tasks by leveraging AI services. As illustrated in FIG. 1, exemplary system 100 may include and/or represent a storage device 102 and/or circuitry 104. In some examples, circuitry 104 may be communicatively and/or electrically coupled to storage device 102 in a network device. In one example, storage device 102 may store, keep, and/or maintain data 106 associated with an OS installed and/or running on the network device.

In some examples, circuitry 104 may detect and/or identify a time-based and/or periodic trigger associated with a task for the network device. For example, circuitry 104 may detect and/or identify a recurring trigger that initiates the performance of a certain task on a periodic basis (e.g., every 10 minutes, every 30 minutes, every hour, every day, every week, etc.). In certain implementations, circuitry 104 may associate and/or map any task with a time-based and/or periodic trigger.

In some examples, circuitry 104 may detect and/or identify an event associated with a task for the network device. Examples of such events include, without limitation, commit operations, configuration changes associated with the operating system, the network device, or a network that includes the network device, status changes associated with an additional network device or a link included in a network, address changes associated with the network device or another network device communicatively coupled (whether directly or indirectly ) to the network device, combinations or variations of one or more of the same, and/or any other suitable events. In certain implementations, circuitry 104 may associate and/or map any task with any event such that, when a given event occurs, the associated and/or mapped task is performed and/or initiated.

As a specific example, circuitry 104 may detect and/or identify one or more configuration changes involved in a commit operation. In this example, circuitry 104 may perform and/or initiate one or more tasks in response to the configuration changes involved in the commit operation. As another example, circuitry 104 may detect and/or identify one or more address changes involving a device and/or link communicatively coupled to the network device. In this example, circuitry 104 may perform and/or initiate one or more tasks in response to the address changes involving the device and/or link.

In some examples, circuitry 104 may execute, perform, and/or implement various steps and/or activities in response to the detection of a certain event or a time-based and/or periodic trigger. For example, in response to the detection of a certain event or a time-based trigger, circuitry 104 may collect data pertinent to a task, prepare an input for an AI service based on that data in connection with the task, and then receive an output corresponding to the task upon injecting the input into the AI service.

In some examples, circuitry 104 may collect, gather, and/or organize a subset of data 126 pertinent to a task for the network device. For example, circuitry 104 may collect subset of data 126 from data 106 associated with the OS. Examples of data 106 and/or subset of data 126 include, without limitation, syslog data, configuration data, address data, state data, link-status data, network data, change logs, operational data, application data, combinations or variations of one or more of the same, and/or any other suitable data.

In some examples, circuitry 104 may prepare, generate, and/or organize an input 108 for an AI service 110 based at least in part on subset of data 126. In one example, circuitry 104 may prepare input 108 in connection with the task for the network device. For example, input 108 may prompt, cause, and/or direct AI service 110 to perform and/or complete the task. Examples of such a task include, without limitation, auditing configurations of the network device or corresponding network, reviewing configuration changes involving the network device or corresponding network, analyzing logs (e.g., syslog data) of the network device or corresponding network, monitoring the operations or performance of the network device or corresponding network, diagnosing issues with the network device or corresponding network, monitoring the health of the network device or corresponding network, combinations or variations of one or more of the same, and/or any other suitable task.

In some examples, circuitry 104 may identify, generate, and/or formulate a query or prompt associated with the task for the network device. In one example, circuitry 104 may incorporate, insert, and/or apply the query and/or prompt in input 108. In this example, the query and/or prompt may direct and/or instruct AI service 110 on how to perform and/or complete some or all of the task. Additionally or alternatively, circuitry 104 may incorporate, insert, and/or apply subset of data 126 in input 108. Accordingly, AI service 110 may utilize and/or rely on subset of data 126 to perform and/or complete some or all of the task in accordance with the direction and/or instruction offered by the query and/or prompt. In other words, by preparing input 108 for AI service 110 in this way, circuitry 104 may enable AI service 110 to answer the query and/or respond to the prompt based at least in part on subset of data 126 upon injecting input 108 into AI service 110.

In some examples, circuitry 104 may associate and/or map any query and/or prompt to a specific task. For example, circuitry 104 may generate and/or formulate a standard query and/or prompt for incorporation into inputs prepared in connection with a specific task in the future. In this example, circuitry 104 may associate and/or map the query and/or prompt to that specific task such that, when a certain event or time-based trigger is detected, circuitry 104 prepares an input for AI service 110 in connection with that specific task. To do so, circuitry 104 may incorporate the query and/or prompt associated with the specific task into the input for injection into AI service 110.

In some examples, circuitry 104 may generate, define, and/or formulate the query or prompt based at least in part on user input obtained from an administrator or user of the network device. For example, an administrator of the network device may provide and/or enter input for the query and/or prompt into a user interface that is communicatively coupled (whether directly or indirectly) to circuitry 104. Accordingly, the query and/or prompt may constitute, include, and/or represent a user-provided or user-defined question, request, and/or instruction.

In some examples, circuitry 104 may associate and/or map certain types of data (e.g., subset of data 126) with the task such that AI service 110 has the data necessary to perform and/or complete the task. In one example, circuitry 104 may tag and/or mark the task (or records associated with and/or representative of the task) with one or more identifiers that indicate one or more features pertinent to the task. For example, circuitry 104 may create a record indicating and/or denoting that a certain task calls for and/or necessitates specific types of data (e.g., subset of data 126) for AI service 110 to be able to perform and/or complete the task. In this example, circuitry 104 may refer to and/or reference such a record when preparing an input for AI service 110 in connection with that task.

In some examples, circuitry 104 may inject and/or submit input 108 into AI service 110 via an input window 118. For example, if AI service 110 represents CHATGPT, then circuitry 104 may cause and/or direct the network device to inject and/or submit input 108 into the context window of CHATGPT. In this example, AI service 110 may perform and/or complete the task in accordance with and/or based at least in part on input 108. AI service 110 may then generate and/or formulate an output 112 corresponding to the task. In certain implementations, output 112 may constitute, include, and/or represent data indicating the result(s) and/or outcome of the task performed and/or completed by AI service 110 in connection with input 108.

In some examples, circuitry 104 may receive and/or obtain output 112 from AI service 110. In one example, circuitry 104 may direct and/or instruct the network device and/or a computing device 114 to present and/or display some or all of output 112 via a user interface 116 and/or a display device. In this example, the administrator and/or user of the network device may be able to view and/or evaluate some or all of output 112 via user interface 116. In certain implementations, circuitry 104 may receive and/or obtain additional user input (e.g., additional queries, prompts, instructions, etc.) from the administrator and/or user to follow up and/or continue interacting with AI service 110 in connection with the task.

In some examples, circuitry 104 may cause and/or direct storage device 102 to store, keep, and/or maintain some or all of output 112 as part of data 106. By doing so, circuitry 104 may be able to reference some or all of output 112 when preparing a subsequent input for AI service 110 in connection with the same sort of task in the future. For example, circuitry 104 may incorporate, insert, and/or apply output 112 into a subsequent input so that AI service 110 is able to utilize and/or rely on output 112 when performing and/or completing that future task. Accordingly, by preparing the subsequent input for AI service 110 in this way, circuitry 104 may enable AI service 110 to answer the corresponding query and/or prompt of the subsequent input based at least in part on output 112 upon injecting the subsequent input into AI service 110. In other words, by preparing the subsequent input for AI service 110 in this way, circuitry 104 may enable AI service 110 to consider, take into account, and/or analyze some or all of output 112 when performing the task.

In some examples, circuitry 104 may publish some or all of output 112 to an AI-driven data bus to distribute messages and/or data corresponding to the task. In one example, circuitry 104 may tag those messages and/or data with identifiers for distribution to subscribers interested in such messages and/or data. For example, the AI-driven data bus may function and/or serve as a distribution channel through which messages and/or data of interest are published to the subscribers’ feeds (e.g., akin to web feeds) and/or corresponding applications running on the subscriber devices. In certain implementations, by publishing and/or tagging such messages and/or data in this way, circuitry 104 may enable the subscribers (e.g., a user of computing device 114) to view and/or evaluate some or all of output 112 via the AI-driven data bus. Additionally or alternatively, circuitry 104 may enable such subscribers to find the portion of output 112 to which they subscribe by filtering through messages and/or data tagged with the corresponding identifiers on the AI-driven data bus.

In some examples, input 108 may include and/or represent a variety of information and/or computer-readable instructions. For example, input 108 may include and/or represent one or more code snippets, one or more descriptions and/or data sets, and/or one or more user queries or prompts. Additionally or alternatively, input 108 may include and/or represent one or more application programming interfaces (APIs) and/or services for interfacing with AI service 110 in the context(s) as defined by an administrator or user. In one example, input 108 may further include and/or represent one or more instructions on the usages of such APIs and/or services.

In some examples, output 112 may include and/or represent a variety of information, computer-readable instructions, and/or text. For example, output 112 may include and/or represent text constituting answers to user queries submitted in input 108. In this example, circuitry 104 may direct and/or instruct the network device and/or computing device 114 to present and/or display output 112 via a user interface 116 and/or a corresponding display device.

In some examples, circuitry 104 may include and/or represent one or more electrical and/or electronic circuits capable of processing, applying, modifying, transforming, displaying, transmitting, receiving, and/or executing data for system 100. Additionally or alternatively, circuitry 104 may launch, perform, and/or execute certain executable files, code snippets, modules, and/or computer-readable instructions to facilitate and/or support integrating chatbots into applications. Although illustrated as a single unit in FIG. 1, circuitry 104 may include and/or represent a collection of multiple processing units, electrical components, and/or devices that work and/or operate in conjunction with one another. Examples of circuitry 104 include, without limitation, application-specific integrated circuits (ASICs), central processing units (CPUs), processing devices, microprocessors, microcontrollers, graphics processing units (GPUs), field-programmable gate arrays (FPGAs), systems-on-chips (SoCs), parallel accelerated processors, tensor cores, integrated circuits, chiplets, optical modules, receivers, transmitters, transceivers, optical modules, portions of one or more of the same, variations or combinations of one or more of the same, and/or any other suitable circuitry.

In some examples, storage device 102 may include and/or represent any type or form of volatile or non-volatile memory or storage medium capable of storing data and/or computer-readable instructions. In one example, storage device 102 may store, load, and/or maintain one or more modules that, when executed and/or implemented, facilitate and/or support performing dynamically loaded tasks by leveraging AI service 110. Examples of storage device 102 include, without limitation, Random Access Memory (RAM), Read Only Memory (ROM), flash memory, Hard Disk Drives (HDDs), Solid-State Drives (SSDs), optical disk drives, caches, buffers, variations or combinations of one or more of the same, and/or any other suitable storage memory.

In some examples, AI service 110 may include and/or represent a generative AI bot, a chatbot, an LLM, a virtual assistant, a generative pretrained transformer, and/or a natural language processing (NLP) bot. For example, AI service 110 may include and/or represent an instance of CHATGPT or GROK. In one example, AI service 110 may execute, run, and/or implement input 108 by passing the same through an LLM to render output 112. Accordingly, AI service 110 may generate and/or produce output 112, which results from and/or corresponds to input 108.

In some examples, the display device on which output 112 is presented may include and/or represent any type or form of hardware capable of displaying visual information and/or features to users. Examples of such a display device include, without limitation, monitors, screens, projectors, televisions, mobile devices, smartphones, combinations or variations of one or more of the same, and/or any other suitable display device. In one example, the display device may include and/or represent any of a variety of sizes, resolutions, and technologies. For example, the display device may implement, incorporate, and/or employ various display technologies, such as liquid crystal displays (LCDs), light-emitting diodes (LEDs), organic LEDs (OLEDs), plasma-based devices, etc. In this example, the display device may render and/or display images, videos, and/or graphical user interfaces (e.g., user interface 116).

In some examples, system 100 may include and/or represent one or more physical computing devices and/or a network of computing devices capable of reading computer-executable instructions and/or handling network traffic. Examples of system 100 include, without limitation, network devices, servers, computing devices, networks, routers, rackmount telecommunications devices, switches, hubs, modems, bridges, repeaters, gateways, multiplexers, network adapters, network interfaces, client devices, laptops, tablets, desktops, variations or combinations of one or more of the same, and/or any other suitable systems.

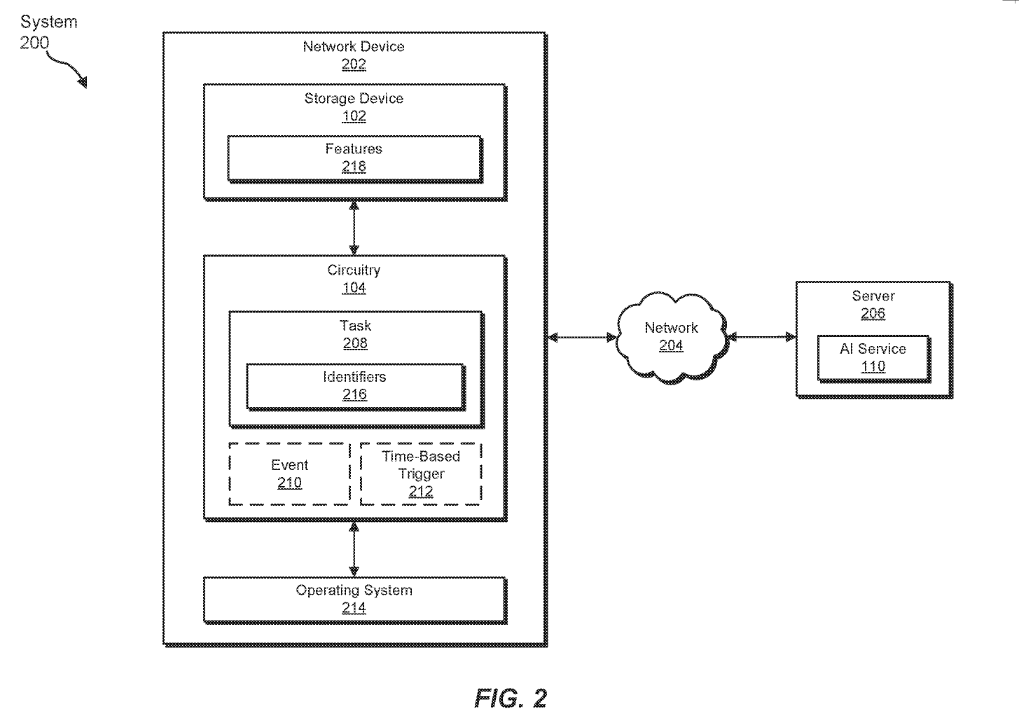

FIG. 2 illustrates an exemplary system 200 that facilitates and/or supports performing dynamically loaded tasks by leveraging AI services. In some examples, system 200 in FIG. 2 may include and/or involve certain devices, components, configurations, and/or features that perform and/or provide functionalities that are similar and/or identical to those described above in connection with FIG. 1. In one example, system 200 may include and/or represent a network device 202 and a server 206 communicatively coupled to one another via a network 204. In certain implementations, although illustrated as being external to and/or outside network 204, network device 202 and/or server 206 may alternatively represent part of and/or be included in network 204.

In some examples, network device 202 may include and/or represent storage device 102 and/or circuitry 104. In one example, network device 202 may execute and/or implement an operating system (OS) 214 via circuitry 104. For example, OS 214 may include and/or represent a network OS (e.g., JUNOS) running on network device 202. In this example, network device 202 may detect an event 210 and/or a time-based trigger 212 associated with a task 208. Additionally or alternatively, event 210 and/or time-based trigger 212 may cause, prompt, and/or direct network device 202 to prepare input 108 for AI service 110 in connection with task 208.

In some examples, network device 202 may inject and/or submit input 108 to AI service 110 via network 204. In one example, server 206 may execute, implement, and/or provide AI service 110. In this example, AI service 110 running on server 206 may perform and/or complete task 208 based at least in part on input 108. AI service 110 may generate and/or produce output 112 detailing one or more result(s) of task 208.

In some examples, network device 202 may receive and/or obtain output 112 from AI service 110 running on server 206. In one example, network device 202 may tag and/or mark task 208 (or records associated with and/or representative of task 208) with one or more identifiers 216 that indicate one or more features 218 pertinent to task 208. For example, network device 202 may create a record and/or metadata indicating and/or denoting that task 208 calls for and/or necessitates specific types of data (e.g., subset of data 126) for AI service 110 to be able to perform and/or complete task 208. In this example, network device 202 may refer to and/or reference this record and/or metadata to identify, locate, and/or collect such data when preparing input 108 for AI service 110 in connection with task 208.

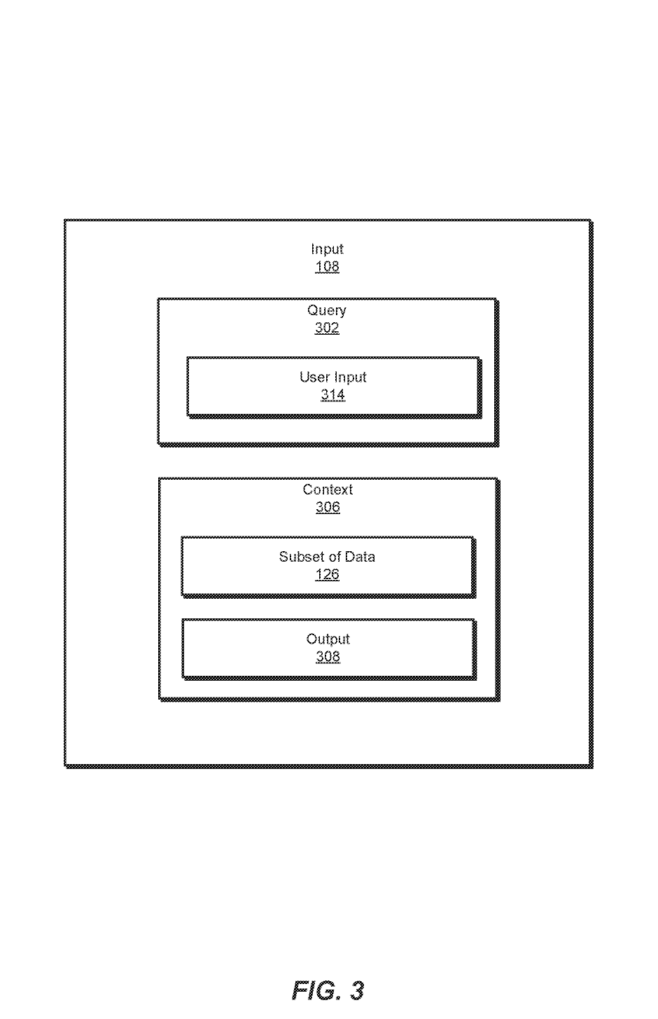

FIG. 3 illustrates an exemplary implementation of input 108 for AI service 110. In some examples, input 108 in FIG. 3 may include and/or involve certain components, configurations, and/or features that perform and/or provide functionalities that are similar and/or identical to those described above in connection with either FIGS. 1 or FIG.2. As illustrated in FIG. 3, exemplary input 108 may include and/or represent a query 302 and/or context 306 for performing a certain task. In one example, query 302 may include and/or represent user input 314 provided and/or entered by an administrator and/or user of network device 202 via a user interface and/or device. For example, query 302 may be defined and/or formulated according to and/or based at least in part on user input 314.

In some examples, context 306 may include and/or represent subset of data 126 and/or output 308. In one example, output 308 may constitute, include, and/or represent a previous output received from AI service 110 in connection with a similar task or a previous instance of the same task. In this example, circuitry 104 may incorporate, insert, and/or apply output 308 into input 108 so that AI service 110 is able to utilize and/or rely on output 308 when performing and/or completing the task based at least in part on input 108. Accordingly, by preparing input 108 for AI service 110 in this way, circuitry 104 may enable AI service 110 to answer query 302 of input 108 based at least in part on output 308 upon injecting input 108 into AI service 110. In other words, by preparing the subsequent input for AI service 110 in this way, circuitry 104 may enable AI service 110 to consider, take into account, and/or analyze some or all of output 308 when performing the task.

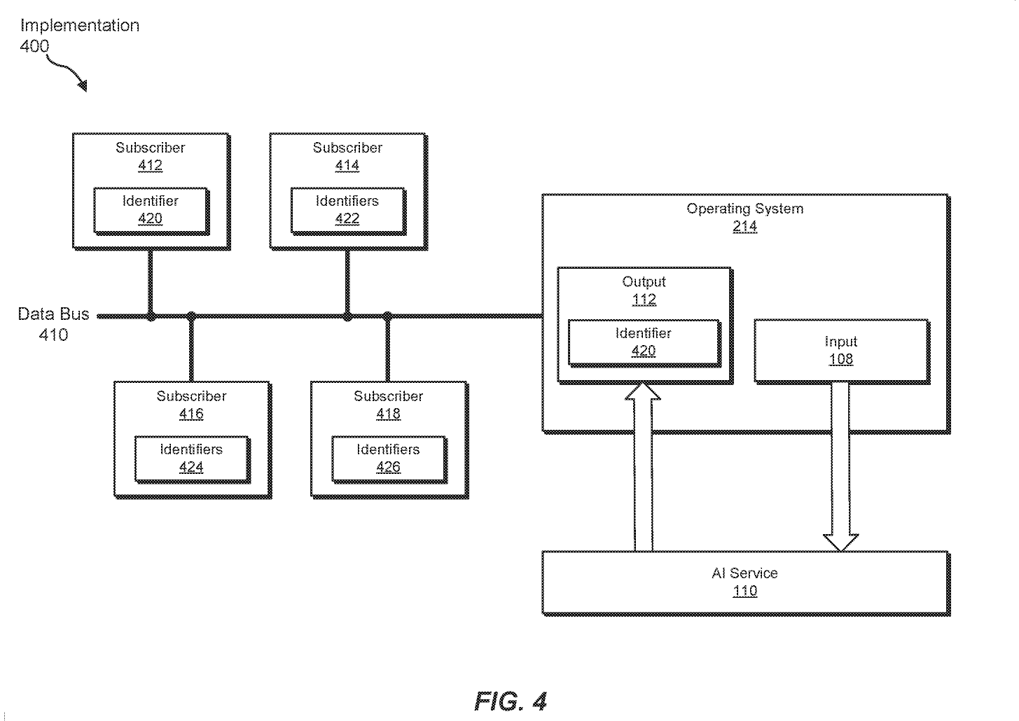

FIG. 4 illustrates an exemplary implementation 400 of a system for performing dynamically loaded tasks by leveraging AI services. In some examples, implementation 400 in FIG. 4 may include and/or involve certain components, configurations, and/or features that perform and/or provide functionalities that are similar and/or identical to those described above in connection with any of FIGS. 1-3. As illustrated in FIG. 4, implementation 400 may include, represent, and/or involve operating system 214, AI service 110, and/or a data bus 410. In one example, OS 214 may prepare and/or generate input 108 for injection into AI service 110 in connection with certain task. In this example, OS 214 may receive and/or obtain output 112 from AI service 110 in response to the injection of input 108.

In some examples, circuitry 104 may publish some or all of output 112 to a data bus 410 to distribute messages and/or data corresponding to the task. In one example, circuitry 104 may tag output 112 with an identifier 420 for distribution to subscribers interested in such messages and/or data. In this example, identifier 420 may correspond to and/or represent the task performed by AI service 110 and/or any results or warnings associated with that task. For example, data bus 410 may function and/or serve as a distribution channel through which messages and/or data of interest are published to the subscribers’ feeds (e.g., akin to web feeds) and/or corresponding applications running on the subscriber devices. In certain implementations, data bus 410 may effectively push output 112 to those subscribers who have requested and/or subscribed to messages and/or data tagged with identifier 420.

As a specific example, implementation 400 may include, represent, and/or involve subscribers 412, 414, 416, and 418 whose devices are communicatively coupled to data bus 410. In this example, subscribers 412, 414, 416, and 418 may have requested and/or subscribed to messages and/or data tagged with identifiers 420, 422, 424, and 426, respectively. In one example, OS 214 may publish output 112 to subscriber 412 via data bus 410 due at least in part to output 112 having been tagged with identifier 420. In certain implementations, subscribers 414, 416, and 418 may fail to receive output 112 via data bus 410 due at least in part to not having requested and/or subscribed to identifier 420.

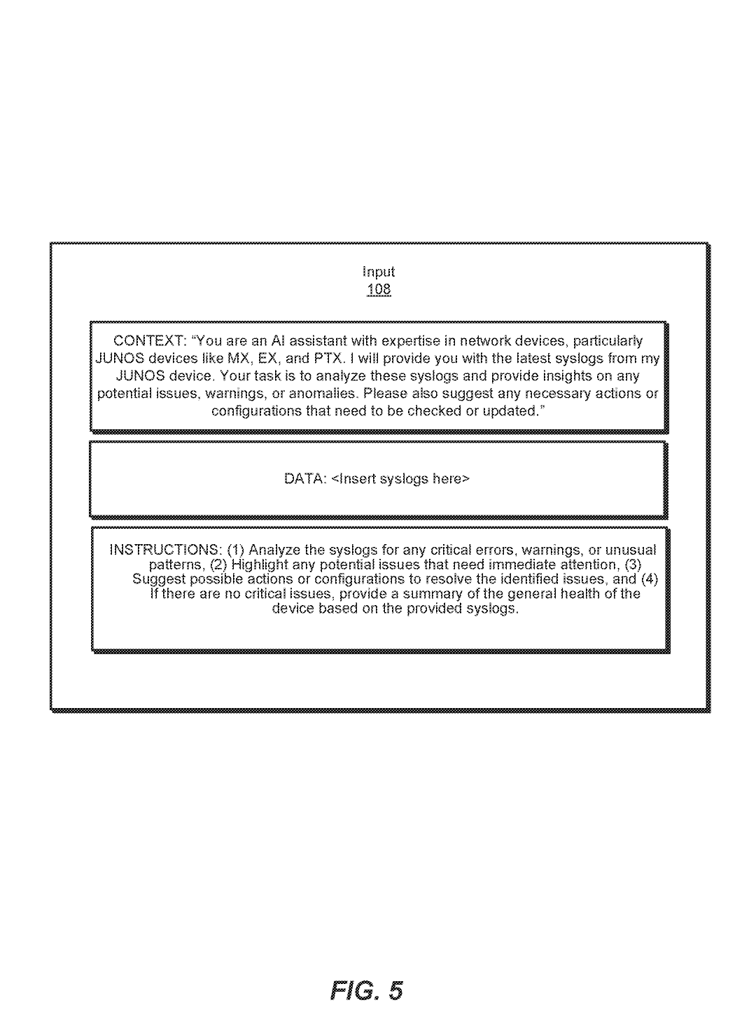

FIG. 5 illustrates an exemplary implementation of input 108 prepared by OS 214 for injection into AI service 110. In some examples, input 108 in FIG. 5 may include and/or involve certain components, configurations, and/or features that perform and/or provide functionalities that are similar and/or identical to those described above in connection with any of FIGS. 1-4. As illustrated in FIG. 5, exemplary input 108 may include and/or represent certain context, data, and/or instructions in the form of text, code, images, etc. In one example, the context of input 108 may include and/or represent text that reads “You are an AI assistant with expertise in network devices, particularly JUNOS devices like MX, EX, and PTX. I will provide you with the latest syslogs from my JUNOS device. Your task is to analyze these syslogs and provide insights on any potential issues, warnings, or anomalies. Please also suggest any necessary actions or configurations that need to be checked or updated.”

In one example, the data of input 108 may include and/or represent syslogs collected by OS 214 for consideration and/or analysis in connection with the task. Additionally or alternatively, the instructions of input 108 may include and/or represent “(1) Analyze the syslogs for any critical errors, warnings, or unusual patterns, (2) Highlight any potential issues that need immediate attention, (3) Suggest possible actions or configurations to resolve the identified issues, and (4) If there are no critical issues, provide a summary of the general health of the device based on the provided syslogs.”

In some examples, the systems described in connection with FIGS. 1-5 may include and/or represent one or more additional devices, circuits, components, and/or features that are not necessarily illustrated and/or labeled in FIGS. 1-5. For example, the systems illustrated in FIGS. 1-5 may also include and/or represent additional network devices, computing devices, controllers, routers, switches, analog and/or digital circuitry, onboard logic, transistors, transmitters, receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components that facilitate and/or support performing dynamically loaded tasks by leveraging AI services. In certain implementations, one or more of these additional devices, circuits, components, and/or features may be inserted and/or applied between any of the existing devices, circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components may constitute and/or represent a coupling in which those two devices or components are directly connected to each other by a single node that provides continuity from one of those two devices or components to the other. In other words, the direct coupling may exclude and/or omit any additional devices or components between those two devices or components.

Additionally or alternatively, an indirect coupling between two devices and/or components may constitute and/or represent a coupling in which those two devices or components are indirectly connected to each other by multiple nodes that fail to provide direct electrical and/or communicative continuity from one of those two devices or components to the other. In other words, the indirect coupling may include and/or incorporate at least one additional device or component between those two devices or components.

FIG. 6 is a flow diagram of an exemplary method 600 for performing dynamically loaded tasks by leveraging AI services. In one example, the steps shown in FIG. 6 may be achieved and/or accomplished by a network device capable of accessing and/or utilizing an AI service. Additionally or alternatively, the steps shown in FIG. 6 may incorporate and/or involve certain sub-steps and/or variations consistent with the descriptions provided above in connection with one or more of FIGS. 1-5.

As illustrated in FIG. 6, method 600 may include the step of storing, by circuitry of a network device, data associated with an operating system of the network device in a storage device (610). Step 610 may be performed in a variety of ways, including any of those described above in connection with FIGS. 1-5. For example, circuitry of a network device may store data associated with an operating system of the network device in a storage device.

Method 600 may also include the step of collecting, by the circuitry from the data associated with the operating system, a subset of data pertinent to a task for the network device (620). Step 620 may be performed in a variety of ways, including any of those described above in connection with FIGS. 1-5. For example, the circuitry of the network device may collect, from the data associated with the operating system, a subset of data pertinent to a task for the network device.

Method 600 may further include the step of preparing, by the circuitry based at least in part on the subset of data, an input for an AI service in connection with the task (630). Step 630 may be performed in a variety of ways, including any of those described above in connection with FIGS. 1-5. For example, the circuitry of the network device may prepare, based at least in part on the subset of data, an input for an AI service in connection with the task.

Method 600 may further include the step of receiving, by the circuitry from the AI service, an output corresponding to the task upon injecting the input into the AI service (640). Step 630 may be performed in a variety of ways, including any of those described above in connection with FIGS. 1-5. For example, the circuitry of the network device may receive, from the AI service, an output corresponding to the task upon injecting the input into the AI service.

FIG. 7 is a block diagram of an exemplary computing system 700 capable of implementing and/or being used in connection with one or more of the embodiments described and/or illustrated herein. In some embodiments, all or a portion of computing system 700 may perform and/or be a means for performing, either alone or in combination with other elements, one or more of the steps described in connection with FIG. 3. All or a portion of computing system 700 may also perform and/or be a means for performing and/or implementing any other steps, methods, or processes described and/or illustrated herein. In one example, computing system 700 may include and/or store all or a portion of certain software modules.

Computing system 700 broadly represents any type or form of electrical load, including a single or multi-processor computing device or system capable of executing computer-readable instructions. Examples of computing system 700 include, without limitation, workstations, laptops, client-side terminals, servers, distributed computing systems, mobile devices, network switches, network routers (e.g., backbone routers, edge routers, core routers, mobile service routers, broadband routers, etc.), network appliances (e.g., network security appliances, network control appliances, network timing appliances, SSL VPN (Secure Sockets Layer Virtual Private Network) appliances, etc.), network controllers, gateways (e.g., service gateways, mobile packet gateways, multi-access gateways, security gateways, etc.), and/or any other type or form of computing system or device.

Computing system 700 may be programmed, configured, and/or otherwise designed to comply with one or more networking protocols. According to certain embodiments, computing system 700 may be designed to work with protocols of one or more layers of the Open Systems Interconnection (OSI) reference model, such as a physical layer protocol, a link layer protocol, a network layer protocol, a transport layer protocol, a session layer protocol, a presentation layer protocol, and/or an application layer protocol. For example, computing system 700 may include a network device configured according to a Universal Serial Bus (USB) protocol, an Institute of Electrical and Electronics Engineers (IEEE) 1394 protocol, an Ethernet protocol, a T1 protocol, a Synchronous Optical Networking (SONET) protocol, a Synchronous Digital Hierarchy (SDH) protocol, an Integrated Services Digital Network (ISDN) protocol, an Asynchronous Transfer Mode (ATM) protocol, a Point-to-Point Protocol (PPP), a Point-to-Point Protocol over Ethernet (PPPoE), a Point-to-Point Protocol over ATM (PPPoA), a Bluetooth protocol, an IEEE 802.XX protocol, a frame relay protocol, a token ring protocol, a spanning tree protocol, and/or any other suitable protocol.

Computing system 700 may include various network and/or computing components. For example, computing system 700 may include at least one processor 714 and a system memory 716. Processor 714 generally represents any type or form of processing unit capable of processing data or interpreting and executing instructions. For example, processor 714 may represent an application-specific integrated circuit (ASIC), a system on a chip (e.g., a network processor), a hardware accelerator, a general purpose processor, and/or any other suitable processing element.

Processor 714 may process data according to one or more of the networking protocols discussed above. For example, processor 714 may execute or implement a portion of a protocol stack, may process packets, may perform memory operations (e.g., queuing packets for later processing), may execute end-user applications, and/or may perform any other processing tasks.

System memory 716 generally represents any type or form of volatile or non-volatile storage device or medium capable of storing data and/or other computer-readable instructions. Examples of system memory 716 include, without limitation, Random Access Memory (RAM), Read Only Memory (ROM), flash memory, or any other suitable memory device. Although not required, in certain embodiments computing system 700 may include both a volatile memory unit (such as, for example, system memory 716) and a non-volatile storage device (such as, for example, primary storage device 732, as described in detail below). System memory 716 may be implemented as shared memory and/or distributed memory in a network device. Furthermore, system memory 716 may store packets and/or other information used in networking operations.

In certain embodiments, exemplary computing system 700 may also include one or more components or elements in addition to processor 714 and system memory 716. For example, as illustrated in FIG. 7, computing system 700 may include a memory controller 718, an Input/Output (I/O) controller 720, and a communication interface 722, each of which may be interconnected via communication infrastructure 712. Communication infrastructure 712 generally represents any type or form of infrastructure capable of facilitating communication between one or more components of a computing device. Examples of communication infrastructure 712 include, without limitation, a communication bus (such as a Serial ATA (SATA), an Industry Standard Architecture (ISA), a Peripheral Component Interconnect (PCI), a PCI Express (PCIe), and/or any other suitable bus), and a network.

Memory controller 718 generally represents any type or form of device capable of handling memory or data or controlling communication between one or more components of computing system 700. For example, in certain embodiments memory controller 718 may control communication between processor 714, system memory 716, and I/O controller 720 via communication infrastructure 712. In some embodiments, memory controller 718 may include a Direct Memory Access (DMA) unit that may transfer data (e.g., packets) to or from a link adapter.

I/O controller 720 generally represents any type or form of device or module capable of coordinating and/or controlling the input and output functions of a computing device. For example, in certain embodiments I/O controller 720 may control or facilitate transfer of data between one or more elements of computing system 700, such as processor 714, system memory 716, communication interface 722, and storage interface 730.

Communication interface 722 broadly represents any type or form of communication device or adapter capable of facilitating communication between exemplary computing system 700 and one or more additional devices. For example, in certain embodiments communication interface 722 may facilitate communication between computing system 700 and a private or public network including additional computing systems. Examples of communication interface 722 include, without limitation, a link adapter, a wired network interface (such as a network interface card), a wireless network interface (such as a wireless network interface card), and any other suitable interface. In at least one embodiment, communication interface 722 may provide a direct connection to a remote server via a direct link to a network, such as the Internet. Communication interface 722 may also indirectly provide such a connection through, for example, a local area network (such as an Ethernet network), a personal area network, a wide area network, a private network (e.g., a virtual private network), a telephone or cable network, a cellular telephone connection, a satellite data connection, or any other suitable connection.

In certain embodiments, communication interface 722 may also represent a host adapter configured to facilitate communication between computing system 700 and one or more additional network or storage devices via an external bus or communications channel. Examples of host adapters include, without limitation, Small Computer System Interface (SCSI) host adapters, Universal Serial Bus (USB) host adapters, IEEE 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 722 may also enable computing system 700 to engage in distributed or remote computing. For example, communication interface 722 may receive instructions from a remote device or send instructions to a remote device for execution.

As illustrated in FIG. 7, exemplary computing system 700 may also include a primary storage device 732 and/or a backup storage device 734 coupled to communication infrastructure 712 via a storage interface 730. Storage devices 732 and 734 generally represent any type or form of storage device or medium capable of storing data and/or other computer-readable instructions. For example, storage devices 732 and 734 may represent a magnetic disk drive (e.g., a so-called hard drive), a solid state drive, a floppy disk drive, a magnetic tape drive, an optical disk drive, a flash drive, or the like. Storage interface 730 generally represents any type or form of interface or device for transferring data between storage devices 732 and 734 and other components of computing system 700.

In certain embodiments, storage devices 732 and 734 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 734 may also include other similar structures or devices for allowing computer software, data, or other computer-readable instructions to be loaded into computing system 700. For example, storage devices 732 and 734 may be configured to read and write software, data, or other computer-readable information. Storage devices 732 and 734 may be a part of computing system 700 or may be separate devices accessed through other interface systems.

Many other devices or subsystems may be connected to computing system 700. Conversely, all of the components and devices illustrated in FIG. 7 need not be present to practice the embodiments described and/or illustrated herein. The devices and subsystems referenced above may also be interconnected in different ways from those shown in FIG. 7. Computing system 700 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives and floppy disks), optical-storage media (e.g., Compact Disks (CDs) and Digital Video Disks (DVDs)), electronic-storage media (e.g., solid-state drives and flash media), and other distribution systems.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of system 100 in FIG. 1 may represent portions of a cloud-computing or network-based environment. Cloud-computing and network-based environments may provide various services and applications via the Internet. These cloud-computing and network-based services (e.g., software as a service, platform as a service, infrastructure as a service, etc.) may be accessible through a web browser or other remote interface. Various functions described herein may also provide network switching capabilities, gateway access capabilities, network security functions, content caching and delivery services for a network, network control services, and/or and other networking functionality.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a storage device configured to store data associated with an operating system running on a network device; and
circuitry configured to:
collect, from the data associated with the operating system, a subset of data pertinent to a task for the network device;
prepare, based at least in part on the subset of data, an input for an artificial intelligent (AI) service in connection with the task; and
receive, from the AI service, an output corresponding to the task upon injecting the input into the AI service.

2. The system of claim 1, wherein the circuitry is further configured to:
detect a time-based trigger associated with the task for the network device; and
prepare the input for the AI service in response to detecting the time-based trigger.

3. The system of claim 1, wherein the circuitry is further configured to:
detect an event associated with the task for the network device; and
prepare the input for the AI service in response to detecting the event.

4. The system of claim 3, wherein the event comprises at least one of:
a commit operation;
a configuration change associated with the operating system, the network device, or a network that includes the network device;
a status change associated with an additional network device or a link included in a network; or
an address change associated with the network device or another network device communicatively coupled to the network device.

5. The system of claim 1, wherein the circuitry is further configured to:
identify a query associated with the task;
incorporate the query and the subset of data into the input; and
enable the AI service to answer the query based at least in part on the subset of data by injecting the input into the AI service.

6. The system of claim 5, wherein the circuitry is further configured to:
generate the query for incorporation into inputs prepared in connection with the task;
associate the query with the task such that, when a certain event or time-based trigger is detected, the input is prepared by incorporating the query and the subset of data for injection into the AI service.

7. The system of claim 5, wherein the circuitry is further configured to:
generate the query based at least in part on user input obtained from an administrator of the network device; and
mapping the subset of data to the task.

8. The system of claim 7, wherein the circuitry is further configured to tag the task with one or more identifiers that indicate one or more features pertinent to the task.

9. The system of claim 1, wherein the circuitry is further configured to:
identify at least a portion of a previous output corresponding to the task as received from the AI service;
incorporate the portion of the previous output and the subset of data into the input; and
enable the AI service to consider the portion of the previous output when generating the output corresponding to the task.

10. The system of claim 1, wherein the circuitry is further configured to store at least a portion of the output in the storage device as part of the data.

11. The system of claim 1, wherein the circuitry is further configured to publish at least portion of the output to a data bus that is accessible to a remote device.

12. The system of claim 11, wherein the circuitry is further configured to enable a user of the remote device to view the portion of the output via the data bus.

13. The system of claim 12, wherein the circuitry is further configured to:
tag the portion of the output with at least one identifier; and
enable the user of the remote device to find the portion of the output by filtering through messages that are tagged with the identifier and are published to the data bus.

14. The system of claim 1, wherein the AI service comprises at least one of:
an artificial intelligence (AI) bot; or
a large language model (LLM).

15. A computer-implemented method comprising:
storing, by circuitry of a network device, data associated with an operating system of the network device in a storage device;
collecting, by the circuitry from the data associated with the operating system, a subset of data pertinent to a task for the network device;
preparing, by the circuitry based at least in part on the subset of data, an input for an artificial intelligent (AI) service in connection with the task; and
receiving, by the circuitry from the AI service, an output corresponding to the task upon injecting the input into the AI service.

16. The computer-implemented method of claim 15, further comprising detecting a time-based trigger associated with the task for the network device; and
wherein preparing the input for the AI service comprises preparing the input in response to detecting the time-based trigger.

17. The computer-implemented method of claim 15, further comprising detecting an event associated with the task for the network device; and
wherein preparing the input for the AI service comprises preparing the input in response to detecting the event.

18. The computer-implemented method of claim 16, wherein:
preparing the input for the AI service comprises:
identifying a query associated with the task; and
incorporating the query and the subset of data into the input; and
injecting the input into the AI service comprises enabling the AI service to answer the query based at least in part on the subset of data.

19. The computer-implemented method of claim 18, further comprising:
generating the query for incorporation into inputs prepared in connection with the task; and
associating the query with the task such that, when a certain event or time-based trigger is detected, the input is prepared by incorporating the query and the subset of data for injection into the AI service.

20. A non-transitory computer-readable medium comprising one or more computer-executable instructions that, when executed by circuitry of a network device, cause the network device to:
store, in a storage device, data associated with an operating system of the network device;
collect, from the data associated with the operating system, a subset of data pertinent to a task for the network device;
prepare, based at least in part on the subset of data, an input for an artificial intelligent (AI) service in connection with the task; and
receive, from the AI service, an output corresponding to the task upon injecting the input into the AI service.
